(19) United States
(12) Patent Application Publication
(10) Pub. No.: US 2014/0049210 A1
(43) Pub. Date: Feb. 20, 2014

(54) POWER SUPPLY CONTROL DEVICE AND METHOD FOR SECONDARY BATTERY

(71) Applicant: SAMSUNG SDI CO., LTD., Yongin-si (KR)

(72) Inventors: Jae-Woo KAM, Yongin-si (KR); Yoon-Phil EO, Yongin-si (KR); In-Kyu PARK, Yongin-si (KR)

(73) Assignee: SAMSUNG SDI CO., LTD., Yongin-si (KR)

(21) Appl. No.: 13/795,465

(22) Filed: Mar. 12, 2013

(30) Foreign Application Priority Data
Aug. 20, 2012 (KR) 10-2012-0090758

(51) Int. Cl. H02J 7/00

(52) U.S. Cl. CPC H02J 7/007; H02J 7/0047
USPC 320/107; 320/134

(57) ABSTRACT

A power supply control device includes a sensing unit that monitors state information of a secondary battery, and a control unit that controls charging/discharging of the secondary battery. In the power supply control device, the sensing unit transmits a warning signal to the control unit when the state information is greater than a predetermined acceptable value, and the control unit cuts off current applied from an external power source to the secondary battery and controls current to be applied from the secondary battery to an electronic device when the warning signal is received by the control unit.

### CLAIM OF PRIORITY

This application makes reference to, incorporates the same herein, and claims all benefits accruing under 35 U.S.C. §119 from an application earlier filed in the Korean Intellectual Property Office on the 20^{th} of Aug. 2012 and there duly assigned Ser. No. 10-2012-0090758.

### BACKGROUND OF THE INVENTION

1. Field of the Invention

An aspect of the present invention relates to a power supply control device and method for a secondary battery, and more particularly, to a power supply control device and method for a secondary battery, which can prevent a swelling phenomenon of the secondary battery.

2. Description of the Related Art

Recently, secondary batteries have been used as power sources of portable electronic devices in many fields, and accordingly, demands on secondary batteries rapidly increase. The secondary batteries can be charged and discharged several times and thus are economically and environmentally effective. Accordingly, the use of the secondary batteries is promoted.

A swelling phenomenon in which a secondary battery swells at a high temperature/high voltage due to gas or the like may occur in the secondary battery. The swelling phenomenon may cause an electrical short circuit. If an external impact is applied to the secondary battery in the state in which the secondary battery swells, a spark or the like occurs, and therefore, the secondary battery may explode.

Conventionally, the swelling phenomenon was overcome in such a manner that an extra space was provided in a battery pack having a secondary battery mounted therein so that a user could not perceive the occurrence of a swelling phenomenon of the secondary battery. However, this manner does not meet the tendency of mobile products that gradually get slimmer, and there is a limitation that this manner does not provide a fundamental solution of the swelling phenomenon.

### SUMMARY OF THE INVENTION

Embodiments provide a power supply control device and method for a secondary battery, which can prevent a swelling phenomenon of the secondary battery by controlling charging and discharging of the secondary battery according to a charging state of the secondary battery.

According to an aspect of the present invention, there is provided a power supply control device for a secondary battery, including: a sensing unit that monitors state information of the secondary battery; and a control unit that controls charging/discharging of the secondary battery, wherein the sensing unit transmits a warning signal to the control unit when the state information is greater than a predetermined acceptable value, and the control unit cuts off current applied from an external power source to the secondary battery and controls current to be applied from the secondary battery to an electronic device when the warning signal is received by the control unit.

The state information may include at least one of temperature information of the secondary battery and charging state information of the secondary battery.

When the temperature information of the secondary battery and the charging state information of the secondary battery are greater than the predetermined acceptable value, the sensing unit may transmit the warning signal to the control unit.

The sensing unit may obtain the charging state information by sensing at least one of an accumulated amount of current of the secondary battery, a voltage of the secondary battery and a state of charge (SOC) of the secondary battery.

The device may further include a switching unit including a first switching circuit coupled to an output terminal of the external power source and an input terminal of the secondary battery, and a second switching circuit coupled to an output terminal of the secondary battery and an input unit of the electronic device. The control unit may control the charging/discharging of the secondary battery using the switching unit.

When the warning signal is received by the control unit, the control unit may control the first switching circuit to be in an off-state, and may control the second switching circuit to be in an on-state.

When the warning signal is not received by the control unit, the control unit may control the first switching circuit to be in an on-state, and may control the second switching circuit to be in an off-state.

The switching unit may further include a third switching circuit coupled to the output terminal of the external power source and the input terminal of the electronic device, and the control unit may control the third switching circuit to be in an off-state when the warning signal is received by the control unit, and may control the third switching circuit to be in an on-state when the warning signal is not received by the control unit.

When the state information is less than the predetermined acceptable value after the sensing unit transmits the warning signal to the control unit, the sensing unit may transmit a safety signal to the control unit.

When the safety signal is received by the control unit, the control unit may control the first and third switching circuit to be in an on-state, and may control the second switching circuit to be in an off-state.

According to an aspect of the present invention, there is provided a power supply control method for a secondary battery, including: monitoring state information of the secondary battery; deciding whether or not the state information is greater than a predetermined acceptable value; and controlling charging/discharging of the secondary battery according to the decided result, wherein the controlling of the charging/discharging of the secondary battery includes cutting off current applied from an external power source to the secondary battery when the state information is greater than the predetermined acceptable value and allowing current to be applied from the secondary battery to an electronic device.

The state information may include at least one of temperature information of the secondary battery and charging state information of the secondary battery.

The deciding may include deciding that the state information is greater than the predetermined acceptable value when the temperature information of the secondary battery and the charging state information of the secondary battery are greater than the predetermined acceptable value.

The monitoring of the state information may include obtaining the charging state information by sensing at least one of an accumulated amount of current of the secondary battery, a voltage of the secondary battery and an SOC of the secondary battery.

The controlling of the charging/discharging of the secondary battery may include cutting off current applied from the external power source to the electronic device when the state information is greater than the predetermined acceptable value.

The controlling of the charging/discharging of the secondary battery may include controlling current to be applied from the external power source to the secondary battery and the electronic device when the state information is less than the predetermined acceptable value.

According to the present invention, it is possible to prevent a swelling phenomenon that occurs in a secondary battery by controlling charging/discharging of a secondary battery according to state information including the temperature and charging state of the secondary battery.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings, in which like reference symbols indicate the same or similar components, wherein:

FIG. 1 is a block diagram schematically showing a power supply control device of an electronic device including a secondary battery according to an embodiment of the present invention;

FIG. 2 is a block diagram showing a detailed configuration of the power supply control device according to the embodiment of the present invention;

FIG. 3 is a block diagram illustrating a switching unit controlled by a control unit according to the embodiment of the present invention; and

FIG. 4 is a flowchart illustrating a power supply control method according to an embodiment of the present invention.

### DETAILED DESCRIPTION OF THE INVENTION

Hereinafter, certain exemplary embodiments according to the present invention will be described with reference to the accompanying drawings. Here, when a first element is described as being coupled to a second element, the first element may be not only directly coupled to the second element but may also be indirectly coupled to the second element via a third element. Further, some of the elements that are not essential to the complete understanding of the invention are omitted for clarity. Also, like reference numerals refer to like elements throughout.

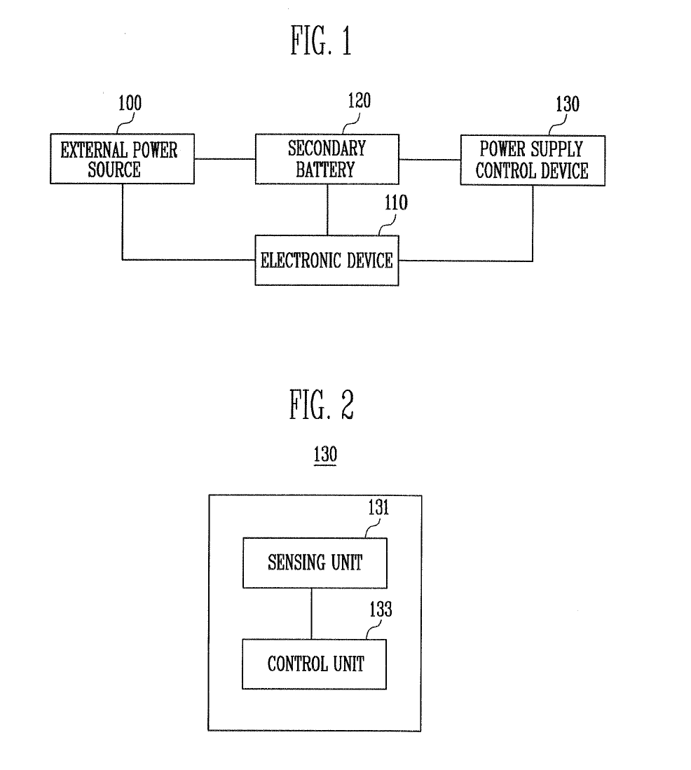

FIG. 1 is a block diagram schematically showing a power supply control device of an electronic device including a secondary battery according to an embodiment of the present invention.

Referring to FIG. 1, a power supply control device 130 is coupled to an electronic device 110 and a secondary battery 120 so as to control current applied to the electronic device 110 and the secondary battery 120. An external power source 100 supplies the current applied to the electronic device 110 and the secondary battery 120.

Here, the external power source 100 refers to a power source that operates the electronic device 110 by applying the current to the electronic device 110 and the secondary battery 120 and charges the secondary battery 120. For example, the external power source 100 may be an AC adapter coupled to the electronic device 110 so as to apply current to the electronic device 110, but the present invention is not limited thereto. That is, the external power source 100 may include all power sources that can apply current to the electronic device 110.

The electronic device 110 refers to a device to which the secondary battery 120 is coupled, such as a cellular phone, a personal digital assistant (PDA), a portable multimedia player (PMP) or a notebook computer, but the present invention is not limited thereto. The electronic device 110 may include all electronic devices that operate using power of the secondary battery 120 or the external power source 100.

The secondary battery 120 refers to a chemical battery that can repeatedly perform storage and radiation of energy by storing electrical energy as chemical energy and radiating chemical energy as electrical energy using the reversibility of an electrochemical reaction. The secondary battery 120 may include a lead-acid battery, a nickel cadmium (NiCd) battery, a nickel metal hydride (NiMH) battery, a lithium ion battery (LiB), a lithium polymer battery (LiPB), and the like.

Generally, in a case where the external power source 100 is coupled to the electronic device 110 to which the secondary battery 120 is coupled, a portion of the current supplied from the external power source 100 is used to operate the electronic device 110, and another portion of the current supplied from the external power source 100 is used to charge the secondary battery 120.

The power supply control device 130 according to the present invention allows current to be applied from the secondary battery 120 to the electronic device 110 by cutting off the current applied to the secondary battery 120 from the external power source 100 and discharging the secondary battery 120 according to state information of the secondary battery 120. Thus, it is possible to prevent, in advance, a swelling phenomenon that occurs in the secondary battery 120.

FIG. 2 is a block diagram showing a detailed configuration of the power supply control device according to the embodiment of the present invention.

Referring to FIG. 2, the power supply control device 130 may include a sensing unit 131 and a control unit 133.

The sensing unit 131 monitors state information of the secondary battery 120. In a case where the state information of the secondary battery 120 is greater than a predetermined acceptable value, the sensing unit 131 transmits a warning signal to the control unit 133.

Here, the state information may include at least one of temperature information of the secondary battery 120 and charging state information of the secondary battery 120. The sensing unit 131 may obtain the charging state information of the secondary battery 120 by sensing an accumulated amount of current of the secondary battery 120, a voltage of the secondary battery 120, a state of charge (SOC) of the secondary battery 120, and the like.

In a case where the temperature and the charging state of the secondary battery 120 is greater than predetermined acceptable values stored in a memory (not shown) of the power supply control device 130, the sensing unit 131 decides that there is a risk that a swelling phenomenon may occur in the secondary battery 120, and transmits a warning signal to the control unit 133.

In a case, for example, where any one of the temperature and charging state of the secondary battery 120 is greater than its predetermined acceptable value but the other of the temperature and charging state of the secondary battery 120 is less than its predetermined acceptable value, the sensing unit 131 decides that the state of the secondary battery 120 is safe. In a case where both the temperature and charging state of the secondary battery 120 are greater than their predetermined acceptable values, the sensing unit 131 decides that there is a risk that the swelling phenomenon may occur in the secondary battery 120, and transmits the warning signal to the control unit 133.

When receiving the warning signal from the sensing unit 131, the control unit 133 cuts off the current applied to the secondary battery 120 from the external power source 100, and allows the current to be applied from the secondary battery 120 to the electronic device 110. That is, the control unit 133 stops the charging of the secondary battery 120 and forcibly discharges the current of the secondary battery 120 to the electronic device 110, so that it is possible to prevent, in advance, the occurrence of the swelling phenomenon by stabilizing the state of the secondary battery 120.

According to an embodiment of the present invention, the power supply control device 130 may further include a switching unit. The control unit 133 may control charging/discharging of the secondary battery 120 using the switching unit.

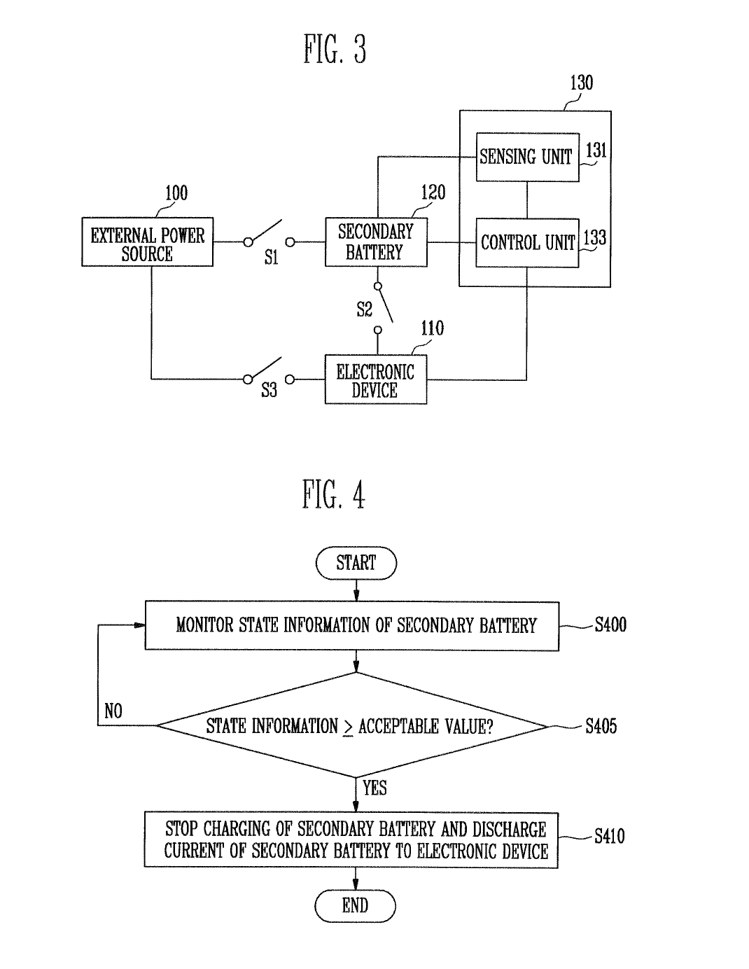

FIG. 3 is a block diagram illustrating a switching unit controlled by the control unit according to the embodiment of the present invention.

Referring to FIG. 3, the switching unit may include a first switching circuit Si coupled to an output terminal of the external power source 100 and an input terminal of the secondary battery 120, a second switching circuit S2 coupled to an output terminal of the secondary battery 120 and an input terminal of the electronic device 110, and a third switching circuit S3 coupled to the output terminal of the external power source 100 and the input terminal of the electronic device 110.

Here, the switching unit is a circuit for controlling electrical connections between the external power source 100, the electronic device 110 and the secondary battery 120. The switching unit may be implemented as an electromechanical switching device, a semiconductor switching device or another switching device.

In a case where the state information of the secondary battery 120 is greater than the predetermined acceptable value, the sensing unit 131 transmits the warning signal to the control unit 133.

While the warning signal is not received by the control unit 133, the control unit 133 controls the first and third switching circuit S1 and S3 to be in an on-state, and controls the second switching circuit S2 to be in an off-state. As the first and third switching circuit S1 and S3 are controlled to be in the on-state, the current supplied from the external power source 100 is applied to the electronic device 110 and the secondary battery 120. As the second switching circuit S2 is controlled to be in the off-state, the current of the secondary battery 120 is not discharged to the electronic device 110.

In a case where the warning signal is received by the control unit 133, the control unit 133 controls the first switching circuit S1 to be in an off-state, and controls the second switching circuit S2 to be in an on-state. As the first switching circuit Si is controlled to be in the off-state, the charging of the secondary battery 120 is stopped. As the second switching circuit S2 is controlled to be in the on-state, the current charged in the secondary battery 120 is applied to the electronic device 110 so that the secondary battery 120 is charged.

Specifically, the charging of the secondary battery 120 is stopped by the current applied from the external power source 100, and the current of the secondary battery 120 is forcibly discharged to the electronic device 110, so that the amount of current charged in the secondary battery 120 is decreased. That is, in a case where there is a risk that the swelling phenomenon may occur in the secondary battery, the amount of current charged in the secondary battery 120 is decreased, so that it is possible to prevent the swelling phenomenon that occurs in the secondary battery 120.

According to an embodiment of the present invention, in a case where the warning signal is received by the control unit 133, the control unit 133 may cut off electrical connection between the external power source 100 and the electronic device 110 by controlling the third switching circuit S3 to be in an off-state. Thus, the discharging of the secondary battery 120 can be more rapidly performed.

According to an embodiment of the present invention, in a case where the state information is less than the predetermined acceptable value after the sensing unit 131 transmits the warning signal to the control unit 133, the sensing unit 131 may transmit a safety signal to the control unit 133.

In a case where the safety signal is received by the control unit 133, the control unit 133 controls the first and third switching circuit S1 and S3 to be in an on-state, and controls the second switching circuit S2 to be in an off-state, so that the charging of the secondary battery 120 can be resumed.

Although it has been described above that the sensing unit 131 is included in the power supply control device 130, the present invention is not limited thereto. That is, the sensing unit 131 may be implemented through a microprocessor module or the like, built in the secondary battery 120. In this case, the control unit 133 may control charging/discharging of the secondary battery 120 by receiving a warning signal detected through the microprocessor module of the secondary battery 120.

FIG. 4 is a flowchart illustrating a power supply control method according to an embodiment of the present invention.

First, in step 400 the sensing unit 131 monitors state information of the secondary battery 120.

Here, the state information of the secondary battery 120 may include temperature information of the secondary battery 120 and/or charging state information of the secondary battery 120.

The sensing unit 131 may be coupled to the secondary battery 120 so as to monitor the state information of the secondary battery 120. The sensing unit 131 may monitor the state information of the secondary battery 120 by sensing an accumulated amount of current of the secondary battery 120, a voltage of the secondary battery 120, a state of charge (SOC) of the secondary battery 120, and the like.

Subsequently, in step 405 the sensing unit 131 decides whether or not the state information of the secondary battery 120 is greater than a predetermined acceptable value. In a case where both the temperature and charging state of the secondary battery 120 are greater than their predetermined acceptable values, the sensing unit 131 may decide that the state information of the secondary battery 120 is greater than the predetermined acceptable value.

Finally, in step 410, when the state information of the secondary battery 120 is determined to be greater than the predetermined acceptable value, the sensing unit 131 stops the charging of the secondary battery 120 and allows current of the secondary battery 120 to be discharged to the electronic device 110. Specifically, the control unit 133 cuts off the current applied from the external power source 100 to the secondary battery 120, and controls the current of the secondary battery 120 to be discharged to the electronic device 110 by coupling the output terminal of the secondary battery 120 to the input terminal of the electronic device 110. The control unit 133 may also cut off the current applied to the electronic device 110 from the external power source 100.

Although not shown, it should be understood that it may be preferable to set up the sensing unit to transmit the warning signal to the control unit when it is determined that the state information is equal to the predetermined acceptable value.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A power supply control device for a secondary battery, comprising:
a sensing unit that monitors state information of the secondary battery; and
a control unit that controls charging and discharging of the secondary battery,
wherein the sensing unit transmits a warning signal to the control unit when the state information is greater than a predetermined acceptable value, and when the warning signal is received by the control unit, the control unit cuts off current applied from an external power source to the secondary battery and controls current to be applied from the secondary battery to an electronic device.

2. The power supply control device according to claim 1, wherein the state information includes at least one of temperature information of the secondary battery and charging state information of the secondary battery.

3. The power supply control device according to claim 2, wherein, when the temperature information of the secondary battery and the charging state information of the secondary battery are greater than the predetermined acceptable value, the sensing unit transmits the warning signal to the control unit.

4. The power supply control device according to claim 2, wherein the sensing unit obtains the charging state information by sensing at least one of an accumulated amount of current of the secondary battery, a voltage of the secondary battery and a state of charge (SOC) of the secondary battery.

5. The power supply control device according to claim 1, further comprising a switching unit comprising a first switching circuit coupled to an output terminal of the external power source and an input terminal of the secondary battery, and a second switching circuit coupled to an output terminal of the secondary battery and an input unit of the electronic device, the control unit controlling the charging and discharging of the secondary battery by controlling on/off states of the first and second switching circuits.

6. The power supply control device according to claim 5, wherein, when the warning signal is received by the control unit, the control unit controls the first switching circuit to be in the off state and controls the second switching circuit to be in the on state.

7. The power supply control device according to claim 5, wherein, when the warning signal is not received by the control unit, the control unit controls the first switching circuit to be in the on state and controls the second switching circuit to be in the off state.

8. The power supply control device according to claim 5, wherein the switching unit further comprises a third switching circuit coupled to the output terminal of the external power source and the input terminal of the electronic device, and the control unit controls the third switching circuit to be in an off state when the warning signal is received by the control unit and controls the third switching circuit to be in an on state when the warning signal is not received by the control unit.

9. The power supply control device according to claim 8, wherein, when the state information is less than the predetermined acceptable value after the sensing unit transmits the warning signal to the control unit, the sensing unit transmits a safety signal to the control unit.

10. The power supply control device according to claim 9, wherein, when the safety signal is received by the control unit, the control unit controls the first and third switching circuits to be in the on state and controls the second switching circuit to be in the off state.

11. A power supply control method for a secondary battery, comprising steps of:
monitoring state information of the secondary battery;
deciding whether or not the state information is greater than a predetermined acceptable value; and
controlling charging and discharging of the secondary battery according to the decided result,
wherein the controlling of the discharging of the secondary battery includes cutting off current applied from an external power source to the secondary battery when the state information is greater than the predetermined acceptable value and allowing current to be applied from the secondary battery to an electronic device.

12. The power supply control method according to claim 11, wherein the state information includes at least one of temperature information of the secondary battery and charging state information of the secondary battery.

13. The power supply control method according to claim 12, wherein the step of deciding includes deciding that the state information is greater than the predetermined acceptable value when the temperature information of the secondary battery and the charging state information of the secondary battery are greater than their predetermined acceptable values.

14. The power supply control method according to claim 12, wherein the step of monitoring of the state information includes obtaining the charging state information by sensing at least one of an accumulated amount of current of the secondary battery, a voltage of the secondary battery and a state of charge (SOC) of the secondary battery.

15. The power supply control method according to claim 11, wherein the step of controlling of the discharging of the secondary battery includes cutting off current applied from the external power source to the electronic device when the state information is greater than the predetermined acceptable value.

16. The power supply control method according to claim 15, wherein the step of controlling of the charging of the secondary battery includes controlling the current to be applied from the external power source to the secondary battery and the electronic device when the state information is less than the predetermined acceptable value.
